(19) United States
(12) Patent Application Publication
(10) Pub. No.: US 2014/0351122 A1
(43) Pub. Date: Nov. 27, 2014

(54) ELECTRONIC-MONEY MANAGEMENT DEVICE, ELECTRONIC-MONEY MANAGEMENT METHOD, ELECTRONIC-MONEY MANAGEMENT PROGRAM, AND COMPUTER-READABLE RECORDING MEDIUM CONTAINING SAID PROGRAM

(71) Applicant: Rakuten, Inc., Shinagawa-ku, Tokyo (JP)

(72) Inventor: Hideki Akashika, Shinagawa-ku (JP)

(73) Assignee: RAKUTEN, INC., Shinagawa-ku, Tokyo (JP)

(21) Appl. No.: 14/368,382

(22) PCT Filed: Dec. 26, 2012
(86) PCT No.: PCT/JP2012/083642

§ 371 Date: Jun. 24, 2014

(30) Foreign Application Priority Data
Dec. 28, 2011 (JP) 2011-288354

(51) Int. Cl. G06Q 20/06; G06Q 20/10

(52) U.S. Cl. CPC G06Q 20/0655; G06Q 20/105
USPC 705/41

(57) ABSTRACT

An electronic money management device according to one embodiment in an electronic money system that stores a balance of electronic money owned by a user in both of a storage device not under control of the user and a storage medium held by the user includes a post-update synchronization unit that, each time the balance in the storage device is updated based on instruction information for changing the balance in the storage device, reflects a change of the balance in the storage device on the balance in the storage medium through a terminal accessible to the storage medium held by the user having the updated balance.

### TECHNICAL FIELD

One aspect of the present invention relates to an electronic money management device, an electronic money management method, an electronic money management program, and a computer-readable recording medium storing the program.

### BACKGROUND ART

A hybrid electronic money system in which both of a server and a chip have electronic money and share the balance of the electronic money has been known. For example, a private electronic value bank system that performs an operation on an electronic wallet through the Internet when an operation is performed on a mobile electronic wallet is disclosed in the following Patent Literature 1. In this system, when an electronic value on a smartcard is used for a service provided in the real environment such as a ticket gate in a station, online transaction does not occur for each use, and an electronic wallet in a bank is updated when a mobile terminal and the bank communicate with each other after that.

### CITATION LIST

### Patent Literature

PTL 1: International Patent Publication No. WO02/39342

### SUMMARY OF INVENTION

### Technical Problem

However, in the system disclosed in the above Patent Literature 1, after the electronic value on the smartcard (chip) changes, it takes a certain time period to reflect the change in the bank (server). Thus, if a change occurs in the balance in the bank during that period, inconsistency of the balance data can occur between the chip and the server.

Accordingly, it is desirable to make sure to maintain consistency of an electronic money balance between a chip and a server.

### Solution to Problem

An electronic money management device according to one aspect of the invention is an electronic money management device in an electronic money system that stores a balance of electronic money owned by a user in both of a storage device not under control of the user and a storage medium held by the user, including a post-update synchronization unit configured to, each time the balance in the storage device is updated based on instruction information for changing the balance in the storage device, reflect a change of the balance in the storage device on the balance in the storage medium through a terminal accessible to the storage medium held by the user having the updated balance.

An electronic money management method according to one aspect of the invention is an electronic money management method performed by an electronic money management device in an electronic money system that stores a balance of electronic money owned by a user in both of a storage device not under control of the user and a storage medium held by the user, including a post-update synchronization step of, each time the balance in the storage device is updated based on instruction information for changing the balance in the storage device, reflecting a change of the balance in the storage device on the balance in the storage medium through a terminal accessible to the storage medium held by the user having the updated balance.

An electronic money management program according to one aspect of the invention causes a computer to function as an electronic money management device in an electronic money system that stores a balance of electronic money owned by a user in both of a storage device not under control of the user and a storage medium held by the user, the program causing the computer to implement a post-update synchronization unit configured to, each time the balance in the storage device is updated based on instruction information for changing the balance in the storage device, reflect a change of the balance in the storage device on the balance in the storage medium through a terminal accessible to the storage medium held by the user having the updated balance.

A computer-readable recording medium according to one aspect of the invention stores an electronic money management program causing a computer to function as an electronic money management device in an electronic money system that stores a balance of electronic money owned by a user in both of a storage device not under control of the user and a storage medium held by the user, the electronic money management program causing the computer to implement a post-update synchronization unit configured to, each time the balance in the storage device is updated based on instruction information for changing the balance in the storage device, reflect a change of the balance in the storage device on the balance in the storage medium through a terminal accessible to the storage medium held by the user having the updated balance.

According to the above aspects, each time the balance in the storage device (which is hereinafter referred to also as “in the server”) not under control of the user is updated, a change of the balance in the storage device is reflected on the balance in the storage medium (which is hereinafter referred to also as “in the chip”) held by the user. Because the balance is thereby synchronized between the storage device and the storage medium each time the balance is updated in the server, it is possible to make sure to maintain consistency of the balance between them.

The electronic money management device according to another aspect may further include a pre-update synchronization unit configured to, before the balance in the storage device is updated based on the instruction information, acquire the balance in the storage medium from the terminal, and reflect a change of the balance in the storage medium on the balance in the storage device using the acquired balance in the storage medium.

In this case, each time the balance in the server is updated, a change of the balance in the chip is reflected on the balance in the server. It is thereby possible to perform the balance update in the server and the following balance synchronization after making sure to reflect a change of the balance in the chip on the server.

In the electronic money management device according to another aspect, the storage device may store balance information containing a user ID identifying a user, the balance in the storage device, information indicating a state of access restriction to the storage medium, and time when processing by the post-update synchronization unit is performed last time, and when the pre-update synchronization unit determines that access to the storage medium has been restricted during a whole period from when processing by the post-update synchronization unit is performed last time to a current time by referring to the balance information corresponding to the user of the terminal, the pre-update synchronization unit may skip processing of reflecting a change of the balance in the storage medium on the balance in the storage device.

When access to the chip has been continuously restricted since the previous synchronization, there is no need to consider a change of the balance in the chip before updating the balance in the server. Thus, by skipping synchronization processing between the server and the chip before update in such a case, it is possible to reduce the processing time for balance update.

In the electronic money management device according to another aspect, the storage device may store balance information containing a user ID identifying a user, the balance in the storage device and information about the balance in the storage medium, and when the pre-update synchronization unit determines that the balance in the storage medium is a specified threshold or more by referring to the balance information corresponding to the user of the terminal, the pre-update synchronization unit may skip processing of reflecting a change of the balance in the storage medium on the balance in the storage device.

In this case, the storage device stores information about the balance in the chip also, and when the balance is a specified threshold or more, synchronization processing between the server and the chip before update is skipped. In this manner, by skipping pre-update synchronization processing when there is a certain amount of the balance in the chip, it is possible to reduce the processing time for balance update.

In the electronic money management device according to another aspect, when the instruction information indicates deposit, the pre-update synchronization unit may skip processing of reflecting a change of the balance in the storage medium on the balance in the storage device.

In the case of performing deposit in the server, there is no need to have concerns about a decrease in the balance in the chip, and therefore by skipping pre-update synchronization processing in this case, it is possible to reduce the processing time for balance update.

In the electronic money management device according to another aspect, the storage device may store balance information containing a user ID identifying a user, the balance in the storage medium, and information indicating a consumed amount out of a freely available amount of the electronic money set for the balance in the storage device, and when the pre-update synchronization unit determines that the consumed amount does not exceed the freely available amount by update of the balance in the storage device based on the instruction information by referring to the balance information corresponding to the user of the terminal, the pre-update synchronization unit skips processing of reflecting a change of the balance in the storage medium on the balance in the storage device.

In this manner, by skipping pre-update synchronization processing when processing of the update unit is completed within the range of the freely available amount set for the update unit of the electronic money management device, it is possible to reduce the processing time for balance update.

In the electronic money management device according to another aspect, when the pre-update synchronization unit skips processing of reflecting a change of the balance in the storage medium on the balance stored in the storage device, the post-update synchronization unit may acquire the balance in the storage medium, recalculate the balance in the storage device after update based on a difference between the balance in the storage medium and the balance in the storage device before update, and transmit the recalculated balance in the storage device to the terminal to thereby reflect a change of the balance in the storage device on the balance in the storage medium.

In this case, when reflecting a change of the balance in the server after update on the balance in the chip, the balance in the server after update is recalculated using a difference between the balance in the chip and the balance in the server before update, and then a change of the recalculated balance in the server is reflected on the balance in the chip. By such a calculation procedure, it is possible to further make sure to maintain consistency of the balance between them.

In the electronic money management device according to another aspect, when processing of reflecting a change of the balance in the storage device on the balance in the storage medium by the post-update synchronization unit remains unperformed, the pre-update synchronization unit may acquire the balance in the storage medium from the terminal, calculate the balance in the storage device before update based on a difference between the balance in the storage medium and the balance in the storage device before update, and update the balance in the storage device.

In the electronic money management device according to another aspect, when an upper limit is set to the balance of the electronic money, the pre-update synchronization unit skips processing of reflecting a change of the balance in the storage medium on the balance in the storage device, and the balance after reflecting a change of the balance in the storage medium on the balance in the storage device after update exceeds the upper limit, the post-update synchronization unit may reflect an excess amount on the balance in the storage medium in next or later processing.

In this manner, by processing the amount of excess of electronic money due to deposit later, it is possible to process all of the deposit amount eventually even when the upper limit is set to the balance of electronic money.

In the electronic money management device according to another aspect, when an upper limit is set to the balance of the electronic money, the pre-update synchronization unit skips processing of reflecting a change of the balance in the storage medium on the balance in the storage device, and the balance after reflecting a change of the balance in the storage medium on the balance in the storage device after update exceeds the upper limit, the post-update synchronization unit may associate an excess amount with the user as a specified service different from the electronic money.

In this manner, by converting the amount of excess of electronic money due to deposit into a different service, it is possible to process all of the deposit amount even when the upper limit is set to the balance of electronic money.

In the electronic money management device according to another aspect, the storage device may store balance information containing a group ID identifying a group sharing one electronic money, a user ID identifying each of users included in the group, and information indicating a consumed amount out of a freely available amount of the electronic money set for each user, and when the pre-update synchronization unit determines that the consumed amount is equal to or less than a specified threshold by referring to the balance information corresponding to the user of the terminal, the pre-update synchronization unit may skip processing of reflecting a change of the balance in the storage medium on the balance in the storage device.

In this case, when the amount of consumption of the freely available amount by one user who shares one electronic money with other users is small, synchronization processing between the server and the chip before update is skipped. In this manner, by skipping pre-update synchronization processing when there is a certain remaining amount of the freely available amount, it is possible to reduce the processing time for balance update.

An electronic money management device according to one aspect of the invention is an electronic money management device in an electronic money system that stores a balance of electronic money owned by a user in both of a storage device not under control of the user and a storage medium held by the user, including a pre-update synchronization unit configured to, before the balance in the storage device is updated based on instruction information for changing the balance in the storage device, acquire the balance in the storage medium stored in the storage medium from a terminal accessible to the storage medium held by the user having the balance to be updated, and reflect a change of the balance in the storage medium on the balance in the storage device using the acquired balance in the storage medium.

An electronic money management method according to one aspect of the invention is an electronic money management method performed by an electronic money management device in an electronic money system that stores a balance of electronic money owned by a user in both of a storage device not under control of the user and a storage medium held by the user, including a pre-update synchronization step of, before the balance in the storage device is updated based on instruction information for changing the balance in the storage device, acquiring the balance in the storage medium stored in the storage medium from a terminal accessible to the storage medium held by the user having the balance to be updated, and reflecting a change of the balance in the storage medium on the balance in the storage device using the acquired balance in the storage medium.

An electronic money management program according to one aspect of the invention causes a computer to function as an electronic money management device in an electronic money system that stores a balance of electronic money owned by a user in both of a storage device not under control of the user and a storage medium held by the user, the program causing the computer to implement a pre-update synchronization unit configured to, before the balance in the storage device is updated based on instruction information for changing the balance in the storage device, acquire the balance in the storage medium stored in the storage medium from a terminal accessible to the storage medium held by the user having the balance to be updated, and reflect a change of the balance in the storage medium on the balance in the storage device using the acquired balance in the storage medium.

A computer-readable recording medium according to one aspect of the invention stores an electronic money management program causing a computer to function as an electronic money management device in an electronic money system that stores a balance of electronic money owned by a user in both of a storage device not under control of the user and a storage medium held by the user, the electronic money management program causing the computer to implement a pre-update synchronization unit configured to, before the balance in the storage device is updated based on instruction information for changing the balance in the storage device, acquire the balance in the storage medium stored in the storage medium from a terminal accessible to the storage medium held by the user having the balance to be updated, and reflect a change of the balance in the storage medium on the balance in the storage device using the acquired balance in the storage medium.

According to the above aspects, before the balance in the storage device (server) is updated, a change of the balance in the storage medium (chip) is reflected on the balance in the storage device. It is thereby possible to perform the balance update in the server after making sure to reflect a change of the balance in the chip on the server.

### Advantageous Effects of Invention

According to one aspect of the present invention, because a balance is synchronized between a server and a chip each time the balance is updated in the server, it is possible to make sure to maintain consistency of the electronic money balance between them.

### BRIEF DESCRIPTION OF DRAWINGS

FIG. 1 is a diagram showing an overall configuration of an electronic money system according to an embodiment.

FIG. 2 is a diagram showing a hardware configuration of a payment terminal shown in FIG. 1.

FIG. 3 is a diagram showing a functional configuration of the payment terminal shown in FIG. 1.

FIG. 4 is a diagram showing an example of server balance information according to an embodiment.

FIG. 5 is a diagram showing a hardware configuration of a management server shown in FIG. 1.

FIG. 6 is a diagram showing a functional configuration of the management server shown in FIG. 1.

FIG. 7 is a sequence chart showing processing of the electronic money system shown in FIG. 1.

FIG. 8 is a sequence chart showing processing of the electronic money system shown in FIG. 1.

FIG. 9 is a diagram showing a configuration of an electronic money management program according to an embodiment.

FIG. 10 is a diagram showing an example of server balance information according to an alternative example.

FIG. 11 is a block diagram showing a functional configuration of a payment terminal and a smartcard according to an alternative example.

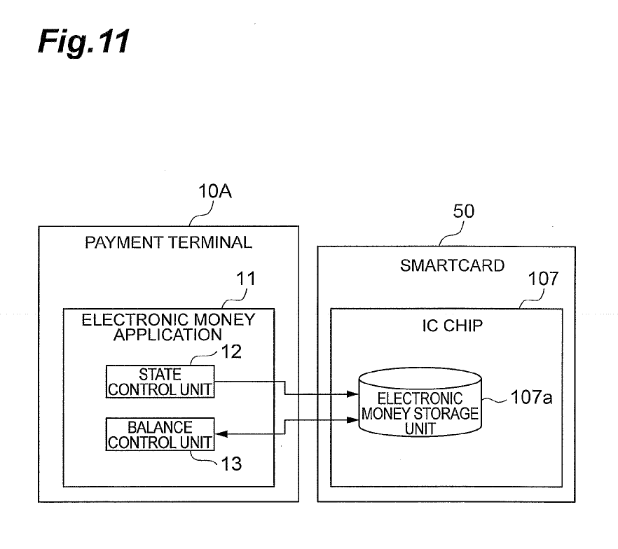

### DESCRIPTION OF EMBODIMENTS

Embodiments of the present invention are described hereinafter in detail with reference to the appended drawings. Note that, in the description of the drawings, the same or equivalent elements are denoted by the same reference symbols, and the redundant explanation thereof is omitted.

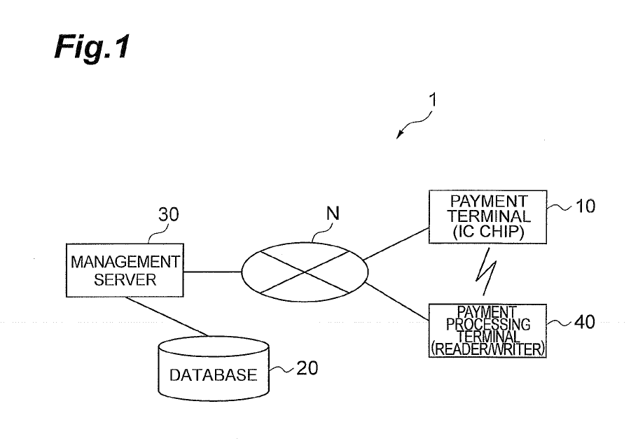

First, the functions and configuration of an electronic money system 1 according to an embodiment are described with reference to FIGS. 1 to 6. The electronic money system 1 is a computer system that manages the balance of electronic money owned by a user. As shown in FIG. 1, the electronic money system 1 includes a payment terminal 10 held by a user, a database (storage device not under control of a user) 20, a management server (electronic money management device) 30, and a payment processing terminal (reader/writer) 40 located at a store or the like. Those devices are connected with one another through a communication network N. Although one payment terminal 10 and one payment processing terminal 40 are shown in FIG. 1, the number of those terminals may be more than one.

In the electronic money system 1, the electronic money of a user is stored in both of an IC chip 107 mounted on the payment terminal 10 and the database 20 on the server side. Hereinafter, the balance stored in the payment terminal 10 (IC chip 107) is referred to as “terminal balance” (second balance), and the balance stored in the database 20 is referred to as “server balance” (first balance).

The payment terminal 10 and the payment processing terminal 40 can transmit and receive data by near field communication, and a user can charge or pay electronic money by the communication, and the terminal balance changes by this processing. The payment processing terminal 40 transmits information about the charging or payment to the server at specified timing, and the server processes the information by a known method.

In this embodiment, processing when the server balance changes, not processing when the terminal balance changes as described above, is described. Example of the case where the server balance changes includes automatic withdrawal, payment for a purchase at an online shopping site, online deposit and the like, though not limited thereto. In this embodiment, every time the server balance changes, the balance of electronic money is synchronized between the database 20 and the payment terminal 10 (IC chip 107). On the other hand, the payment processing terminal 40 that performs deposit or payment processing for the payment terminal 10 does not always send the deposit or payment information to the server in real time. For example, there is a case where the payment processing terminal 40 is offline. Thus, when synchronizing the balance, it is necessary to take a difference in the balance between the server and the terminal into consideration.

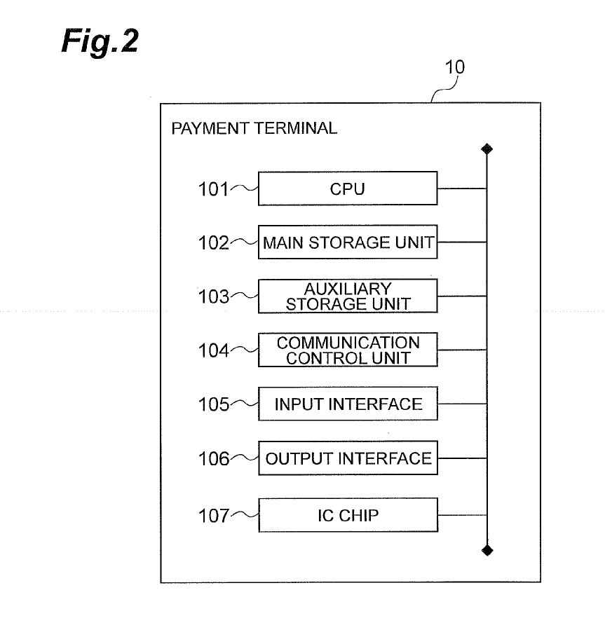

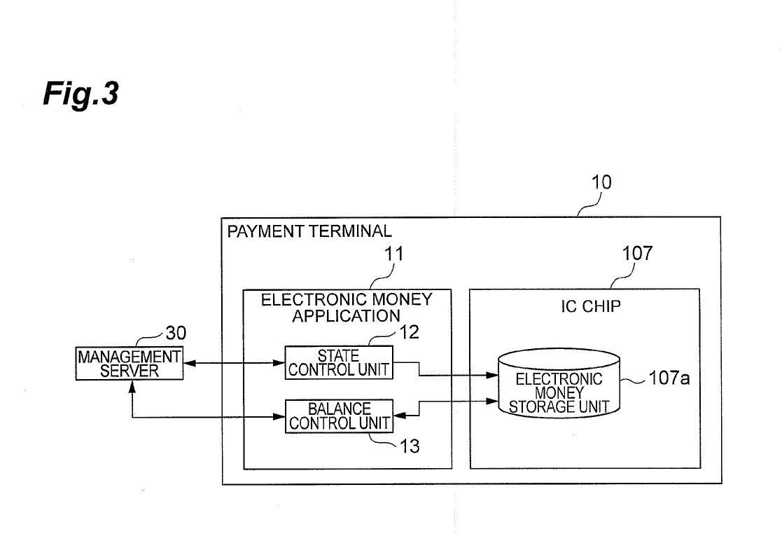

The functions and configuration of the payment terminal 10 are described hereinafter with reference to FIGS. 2 and 3. The variety of the payment terminal 10 is not particularly limited, and it may be a mobile terminal such as a cellular phone, an advanced mobile phone (smart phone), or a personal digital assistant (PDA), for example.

As shown in FIG. 2, the payment terminal 10 includes a CPU 101 that executes an operating system, an application program and the like, a main storage unit 102 such as ROM and RAM, an auxiliary storage unit 103 such as a flash memory, a communication control unit 104 that makes connections for communications with a mobile communication network or a wireless LAN, an input interface 105 such as a touch panel and a key, an output interface 106 such as a display and a speaker, and the IC chip 107 (storage medium owned by a user).

The functional components of the payment terminal 10, which are described later, are implemented by loading given software onto the CPU 101 or the main storage unit 102, making the communication control unit 104, the input interface 105, the output interface 106 and the like operate under control of the CPU 101, and performing reading and writing of data in the main storage unit 102, the auxiliary storage unit 103 or the IC chip 107. The data and database required for processing are stored in the main storage unit 102, the auxiliary storage unit 103 or the IC chip 107.

The IC chip 107 of the payment terminal 10 is an electronic module composed of physical elements such as CPU, RAM, ROM and EEPROM. The IC chip 107 has a function of storing information into a storage area formed inside and a function of reading information from the storage area or rewriting information stored in the storage area according to an externally input command.

As shown in FIG. 3, the IC chip 107 includes an electronic money storage unit 107a. The electronic money storage unit 107a stores a user ID that identifies a user, the terminal balance, state information indicating whether the electronic money is accessible or not (in other words, whether it is locked or not), records of deposits and withdrawals during a specified period and the like. The IC chip 107 can execute settlement (for example, payment and charging) of the electronic money by increasing or decreasing the balance stored inside according to a command from the payment processing terminal 40.

In the payment terminal 10, an electronic money application 11 for controlling the electronic money in the electronic money storage unit 107a is installed. The electronic money application 11 is a program that controls the IC chip 107 according to an instruction signal from the management server 30 or a user operation. The electronic money application 11 includes a state control unit 12 and a balance control unit 13 as functional components.

The state control unit 12 is a means of controlling and monitoring the state of the electronic money. To be specific, the state control unit 12 controls access to the electronic money based on a user operation and the like. For example, the state control unit 12 sets the electronic money to a locked state or an unlocked state. The locked state is a state where the electronic money in the IC chip 107 is not usable, and the unlocked state is a state where the restriction is released and the electronic money is usable. When the state control unit 12 switches between the locked and unlocked states, it transmits a state notification containing a user ID and the state after switching to the management server 30.

A method of controlling the access to the IC chip 107 is not particularly limited. For example, the IC chip 107 may be locked entirely. Alternatively, the payment processing terminal 40 may check a flag in the IC chip 107 at the beginning of settlement processing and, if the flag is ON, send an error notification as a response without proceeding to the subsequent processing to thereby make access control. Alternatively, a specified area in the IC chip 107 may be hidden, and the IC chip may make no response (or sends a code indicating that there is no such an area) to an access command to the hidden area to thereby make access control. Alternatively, access restriction may be imposed individually on a specific storage area in the IC chip 107.

Note that the management server 30 may connect to the payment terminal 10 and transmit a command to lock the whole or a part of the area of the IC chip 107 to the IC chip 107 through the payment terminal 10. In this case, the IC chip 107 sends a response to the command to the management server 30. In this manner, when the management server 30 directly controls the IC chip 107 using the payment terminal 10 as a relay, a state notification is not needed.

Further, the state control unit 12 monitors a change in the terminal balance, and when the balance becomes equal to or less than a specified threshold (for example, ¥2000 or ¥5000), or when the balance exceeds the threshold, generates a change notification indicating the user ID and the event and sends it to the management server 30. Note that the threshold may be freely set by a user or may be preset by an electronic money manager. Processing of the management server 30 based on the change notification is described later.

The balance control unit 13 is a means of performing processing related to the terminal balance based on a notification from the management server 30. When the balance control unit 13 receives an inquiry request from the management server 30, it reads the terminal balance from the electronic money storage unit 107a and generates a balance notification that contains the balance and the user ID. Then, the balance control unit 13 sends the balance notification to the management server 30 as a response to the inquiry request. Further, when the balance control unit 13 receives a synchronization request from the management server 30, it stores the server balance contained in the request into the electronic money storage unit 107a and thereby overwrites the terminal balance. By this update, the server balance and the terminal balance become consistent with each other.

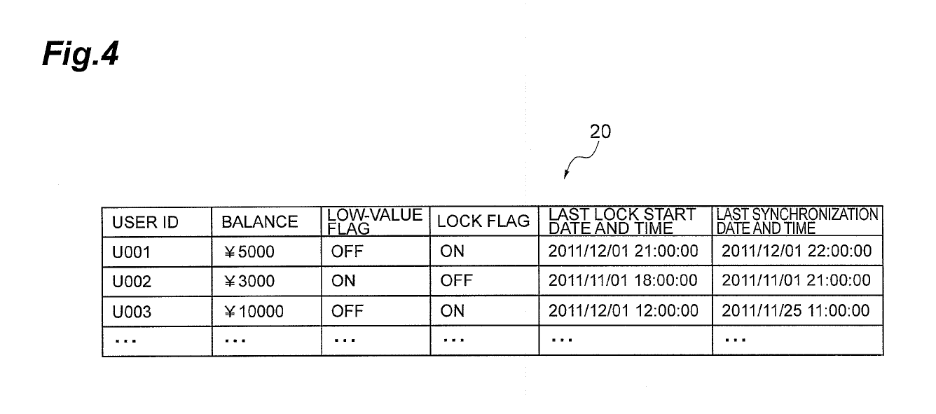

The database 20 is a device that stores server balance information indicating the server balance of each user. As shown in FIG. 4, the server balance information contains a user ID that identifies a user, the server balance of the user, a low-value flag, a lock flag, last lock start date and time, and last synchronization date and time. The low-value flag is information indicating whether the terminal balance is a certain amount or less, which is indicated by ON (the terminal balance is equal to or less than a threshold) or OFF (the terminal balance is more than the threshold). The lock flag is information indicating whether the electronic money in the payment terminal 10 is locked or not, which is indicated by ON (locked) or OFF (unlocked). The last lock start date and time is the date and time when the electronic money is locked last time, and the last synchronization date and time is the date and time when the server balance and the terminal balance are synchronized last time.

For example, FIG. 4 shows that the server balance of the user with the user ID “U001” is ¥5000, and the terminal balance of the user is not determined as a low value. Further, the electronic money in the terminal of the user has been locked since 9 pm on Dec. 1, 2011. Further, the electronic money of the user is synchronized last time at 10 pm on Dec. 1, 2011.

Note that the structure of the database 20 (server balance information) is not limited to the one shown in FIG. 4, and the database 20 may be normalized or made redundant by an arbitrary policy.

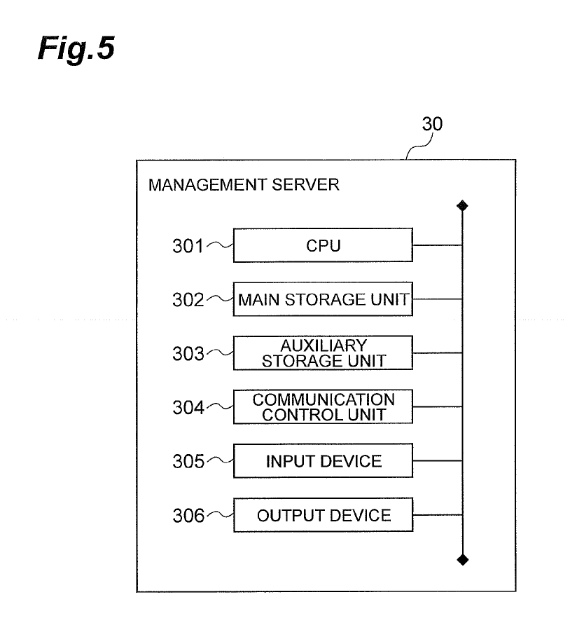

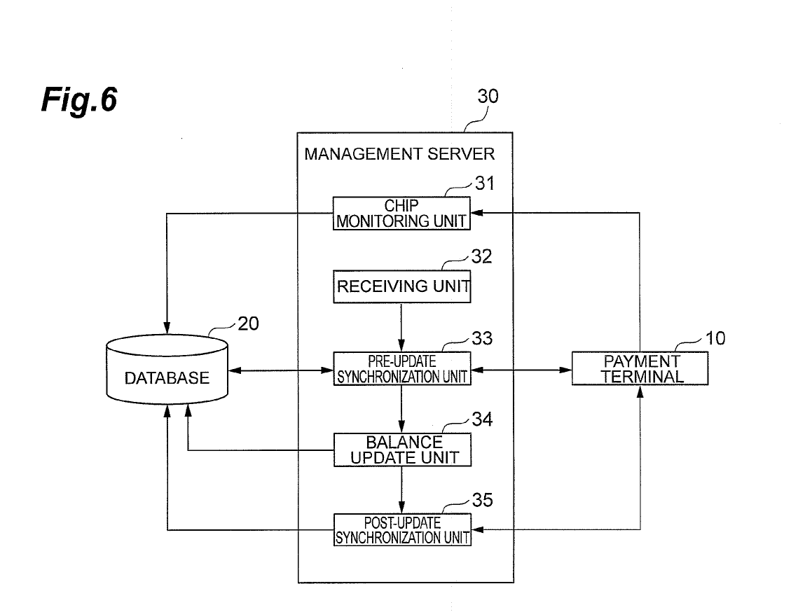

The functions and configuration of the management server 30 are described hereinafter with reference to FIGS. 5 and 6. The management server 30 is a computer that achieves synchronization between the server balance and the terminal balance.

As shown in FIG. 5, the management server 30 includes a CPU 301 that executes an operating system, an application program and the like, a main storage unit 302 such as ROM and RAM, an auxiliary storage unit 303 such as a hard disk, a communication control unit 304 such as a network card, an input device 305 such as a keyboard and a mouse, and an output device 306 such as a display.

The functional components of the management server 30, which are described later, are implemented by loading given software onto the CPU 301 or the main storage unit 302, making the communication control unit 304, the input device 305, the output device 306 and the like operate under control of the CPU 301, and performing reading and writing of data in the main storage unit 302 or the auxiliary storage unit 303. The data and database required for processing are stored in the main storage unit 302 or the auxiliary storage unit 303. Although the management server 30 is composed of one computer in the example of FIG. 5, the functions of the management server 30 may be distributed among a plurality of computers.

As shown in FIG. 6, the management server 30 includes a chip monitoring unit 31, a receiving unit 32, a pre-update synchronization unit 33, a balance update unit 34, and a post-update synchronization unit 35 as functional components.

The chip monitoring unit 31 is a means of receiving a notification about the state of the IC chip 107 from the payment terminal 10 and updating the corresponding server balance information according to the notification. When receiving a change notification, the chip monitoring unit 31 updates the low-value flag of the corresponding server balance information to ON or OFF based on the notification. When receiving a state notification, the chip monitoring unit 31 updates the lock flag of the corresponding server balance information to ON or OFF based on the notification, and when updating the lock flag to ON, updates the last lock start date and time to the current date and time.

The receiving unit 32 is a means of receiving an instruction (instruction information) for payment or charge to the electronic money stored in the database 20, not the electronic money stored in the payment terminal 10. An example of this instruction is automatic withdrawal as described above, through the type of the instruction received by the receiving unit 32 is not limited. The instruction information contains a user ID and the amount of withdrawal or the amount of deposit (which is also referred to hereinafter as “the amount of change”). The receiving unit 32 outputs the instruction information to the pre-update synchronization unit 33.

The pre-update synchronization unit 33 is a means of reflecting a change in the terminal balance on the server balance before changing the server balance. The synchronization processing is referred to hereinafter as “pre-update synchronization”. In the following, a procedure to easily reflect a change in the terminal balance on the server balance is described based on the assumption that, each time the server balance changes, the change is reflected on the terminal balance by the post-update synchronization unit 35, which is described later.

The pre-update synchronization unit 33 extracts the server balance information corresponding to the user ID contained in the instruction information from the database 20. Then, the pre-update synchronization unit 33 determines whether pre-update synchronization can be skipped or not based on the server balance information. A method of the determination is not limited to one.

For example, the pre-update synchronization unit 33 may skip pre-update synchronization when the electronic money in the payment terminal 10 has been locked without interruption during the period between the last time the server balance and the terminal balance were synchronized and the current time. Specifically, when, in the extracted server balance information, the lock flag is ON and the last lock start date and time is before the last synchronization date and time, the pre-update synchronization unit 33 can skip pre-update synchronization. This is because, if the terminal balance is in the state of not being able to change in the payment terminal 10 after the last synchronization processing, the server balance and the terminal balance are not different from each other.

Referring to FIG. 4, because the lock flag of the user “U001” is ON, and the last lock start date and time is before the last synchronization date and time, the pre-update synchronization unit 33 determines that pre-update synchronization is not needed for the user. On the other hand, because the lock flag of the user “U002” is OFF, the pre-update synchronization unit 33 determines that pre-update synchronization is needed for the user. Further, while the lock flag of the user “U003” is ON, because the last lock start date and time is after the last synchronization date and time, the pre-update synchronization unit 33 determines that pre-update synchronization is needed for the user.

As another method, the pre-update synchronization unit 33 may skip pre-update synchronization when a certain amount or more of the electronic money remains in the payment terminal 10, that is when the low-value flag is OFF. This is because, when there is a sufficient amount of the terminal balance, even if the terminal balance changes independently in the payment terminal 10, the amount of change indicated by the instruction information is likely to be absorbed by the payment terminal 10 as well. Referring to FIG. 4, the pre-update synchronization unit 33 determines that pre-update synchronization is not needed for the users “U001” and “U003”, and that pre-update synchronization is needed for the user “U002”.

As another method, the pre-update synchronization unit 33 may skip pre-update synchronization when the instruction information indicates deposit. This is because there is no possibility that both of the server balance and the terminal balance falls below 0 in this case.

When the pre-update synchronization unit 33 determines that pre-update synchronization is not needed, it outputs the instruction information to the balance update unit 34 without performing the synchronization processing.

On the other hand, when the pre-update synchronization unit 33 determines that pre-update synchronization is needed, it transmits an inquiry request to the payment terminal 10 corresponding to the user ID indicated by the extracted server balance information in order to acquire the terminal balance from the payment terminal 10. After that, the pre-update synchronization unit 33 receives a balance notification sent from the payment terminal 10 in response to the inquiry request. Then, the pre-update synchronization unit 33 reflects a change in the terminal balance indicated by the balance notification on the balance indicated by the server balance information (in this example, the server balance is made consistent with the terminal balance). After synchronizing the balance between them, the pre-update synchronization unit 33 outputs the instruction information to the balance update unit 34.

The balance update unit 34 is a means of updating the server balance based on the instruction information. The balance update unit 34 specifies the server balance information corresponding to the user ID indicated by the instruction information and subtracts the amount of withdrawal from the server balance or adds the amount of deposit to the server balance. After updating the server balance in this manner, the balance update unit 34 outputs the user ID to the post-update synchronization unit 35. In addition to such processing of balance update, the balance update unit 34 performs processing to send money to those withdraw the electronic money or receive money from those deposit the electronic money.

Note that, when the amount of withdrawal exceeds the server balance when executing the processing of withdrawal, the balance update unit 34 may deal with it by a known method. For example, the balance update unit 34 may stop the withdrawal. Alternatively, if a user has made registration for automatic charging in advance, the balance update unit 34 may automatically charge at least the amount of shortfall from the credit facility of a specified credit card or the saving account to the server balance and then execute the processing of withdrawal. Alternatively, if a user has made approval for automatic cashing in advance, the balance update unit 34 may automatically reload at least the amount of shortfall by cashing to the server balance and then execute the processing of withdrawal.

The post-update synchronization unit 35 is a means of reflecting a change in the server balance updated by the balance update unit 34 on the terminal balance. The synchronization processing is referred to hereinafter as “post-update synchronization”.

When pre-update synchronization has been performed by the pre-update synchronization unit 33, the post-update synchronization unit 35 extracts the server balance information corresponding to the input user ID from the database 20 and sends a synchronization request containing the server balance indicated by the information to the payment terminal 10 corresponding to the user ID. As described above, the payment terminal 10 that has received the synchronization request overwrites the terminal balance with the server balance. After the server balance and the terminal balance become consistent with each other by this processing, the post-update synchronization unit 35 overwrites the last synchronization date and time in the server balance information with the current date and time.

When pre-update synchronization is skipped due to the reason that the electronic money in the payment terminal 10 has been locked without interruption during the period from the last synchronization between the server balance and the terminal balance to the current time also, the post-update synchronization unit 35 performs post-update synchronization in the same manner as when pre-update synchronization is performed.

On the other hand, when pre-update synchronization is skipped based on the determination result by the low-value flag or the instruction information indicating deposit, merely overwriting the terminal balance with the server balance after update results in that a change in the terminal balance that has not been reflected on the server is cleared. To avoid this, in this case, the post-update synchronization unit 35 performs processing just like pre-update synchronization before performing post-update synchronization.

Specifically, the post-update synchronization unit 35 sends an inquiry request to the payment terminal 10 corresponding to the input user ID in order to acquire the terminal balance from the payment terminal 10. After that, the post-update synchronization unit 35 receives a balance notification sent from the payment terminal 10 in response to the inquiry request. Then, the post-update synchronization unit 35 calculates a difference between the terminal balance indicated by the notification and the server balance before update. Note that the server balance before update may be acquired and stored in advance by the pre-update synchronization unit 33 or the balance update unit 34. Then, the post-update synchronization unit 35 adds or subtracts the difference to or from the server balance after update and thereby recalculates the updated server balance. In this manner, after reflecting a change of the electronic money in the IC chip 107 that has not been reflected on the server balance in the database 20, the post-update synchronization unit 35 sends a synchronization request containing the final server balance to the payment terminal 10. The payment terminal 10 then overwrites the terminal balance with the recalculated server balance and thereby achieves synchronization in the balance.

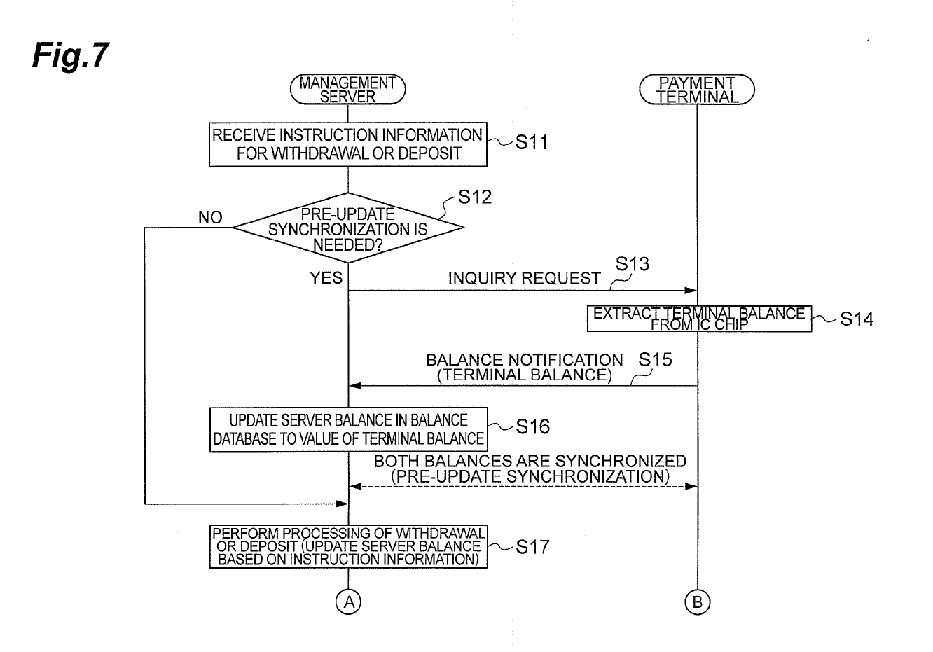

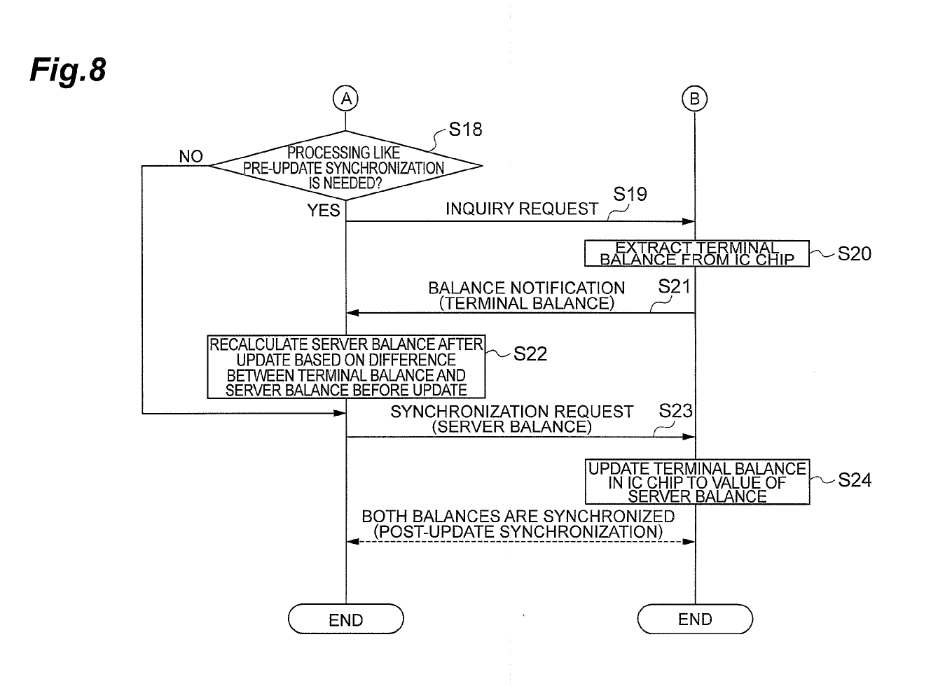

The operations of the management server 30 and the payment terminal 10 are described and further an electronic money management method according to this embodiment is described hereinafter with reference to FIGS. 7 and 8.

When the receiving unit 32 receives instruction information about withdrawal or deposit (Step S11, receiving step), the pre-update synchronization unit 33 determines whether pre-update synchronization is needed prior to updating the server balance based on the instruction information (Step S12). As described above, the pre-update synchronization unit 33 determines whether pre-update synchronization is needed or not based on at least one of the low-value flag, the lock flag, the last lock start date and time and the last synchronization date and time indicated by the server balance information. Alternatively, the pre-update synchronization unit 33 may determine whether pre-update synchronization is needed or not based on the instruction information (withdrawal or deposit).

When the pre-update synchronization unit 33 determines that pre-update synchronization is needed (YES in Step S12), the pre-update synchronization unit 33 sends an inquiry request to the payment terminal 10 (Step S13). In response to the request, the payment terminal 10 extracts the terminal balance from the IC chip 107 (Step S14) and sends a balance notification indicating the balance to the management server 30 (Step S15). The pre-update synchronization unit 33 receives the balance notification and updates the corresponding server balance in the database 20 to the value of the terminal balance indicated by the notification (Step S16). The terminal balance is thereby reflected on the server balance before the server balance is changed in the management server 30 (pre-update synchronization step). On the other hand, when the pre-update synchronization unit 33 determines that pre-update synchronization is not needed (NO in Step S12), the processing of Steps S13 to S16 is skipped.

After that, the balance update unit 34 updates the server balance based on the instruction information and thereby executes the processing of withdrawal or deposit (Step S17, update step).

After the server balance changes by this processing, processing (post-update synchronization step) by the post-update synchronization unit 35 is performed. First, the post-update synchronization unit 35 determines whether processing like pre-update synchronization is needed or not (Step S18). When the post-update synchronization unit 35 determines that such processing is needed (YES in Step S18), the post-update synchronization unit 35 sends an inquiry request to the payment terminal 10 (Step S19). In response to the request, the payment terminal 10 extracts the terminal balance from the IC chip 107 (Step S20) and sends a balance notification indicating the balance to the management server 30 (Step S21). The post-update synchronization unit 35 receives the balance notification and recalculates the server balance after update based on a difference between the terminal balance and the server balance before update (Step S22).

Then, the post-update synchronization unit 35 extracts the processed server balance from the database 20 and sends a synchronization request containing the balance to the payment terminal 10 (Step S23). In response to the request, the payment terminal 10 updates the terminal balance in the IC chip 107 to the value of the server balance (Step S24). The server balance is thereby reflected on the terminal balance in accordance with the update of the server balance in the management server 30 (post-update synchronization).

On the other hand, when the pre-update synchronization is determined not to be needed (NO in Step S18), the processing of Steps S19 to S22 is skipped.

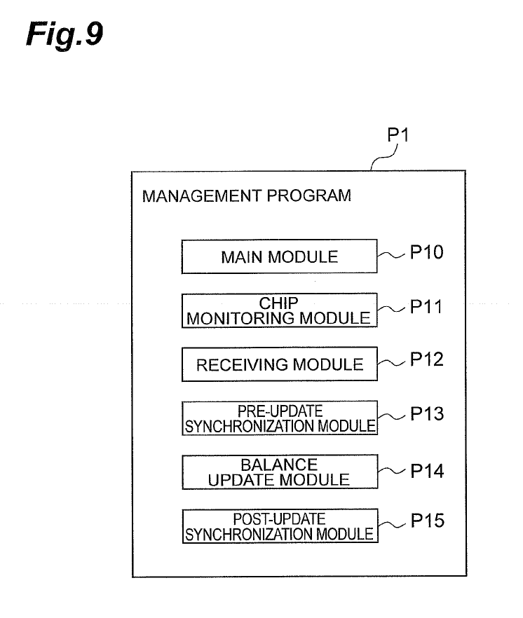

A management program (electronic money management program) P1 that causes a computer to function as the management server 30 is described hereinafter with reference to FIG. 9.

The management program P1 includes a main module P10, a chip monitoring module P11, a receiving module P12, a pre-update synchronization module P13, a balance update module P14, and a post-update synchronization module P15.

The main module P10 is a part that exercises control over the electronic money management function. The functions implemented by executing the chip monitoring module P11, the receiving module P12, the pre-update synchronization module P13, the balance update module P14 and the post-update synchronization module P15 are equal to the functions of the chip monitoring unit 31, the receiving unit 32, the pre-update synchronization unit 33, the balance update unit 34, and the post-update synchronization unit 35 described above, respectively.

The management program P1 is provided in the form of being recorded in a static manner on a tangible recording medium such as CD-ROM or DVD-ROM or semiconductor memory, for example. Further, the management program P1 may be provided as a data signal superimposed onto a carrier wave through a communication network.

As described above, according to this embodiment, each time the balance in the database 20 (the server) is updated, a change in the balance in the server is reflected on the balance in the IC chip 107. The balance is thereby synchronized between the database 20 and the IC chip 107 at each balance update in the server, and it is thereby possible to make sure to maintain consistency of the balance between them.

Further, in this embodiment, pre-update synchronization is performed, and therefore it is possible to perform the balance update in the server and the following balance synchronization after making sure to reflect a change in the balance in the IC chip 107 on the server.

In this embodiment, if pre-update synchronization is skipped when access to the IC chip 107 has been continuously restricted since the previous synchronization, it is possible to reduce the processing time for balance update. Further, the same effect can be achieved also if pre-update synchronization is skipped when the terminal balance is a certain amount or more and if pre-update synchronization is skipped when the instruction information indicates deposit.

Further, when reflecting a change in the updated server balance on the terminal balance, the server balance after update is recalculated using a difference between the terminal balance and the server balance before update, and then the terminal balance is overwritten with the recalculated server balance, and it is thereby possible to further make sure to maintain consistency of the balance between them.

Hereinbefore, the present invention has been described in detail with respect to the embodiment thereof. However, the present invention is not limited to the above-described embodiment. Various changes and modifications may be made therein without departing from the scope of the invention.

In the case of sharing one electronic money among a plurality of users in a group (for example, when sharing electronic money among family members), the pre-update synchronization unit 33 may determine whether pre-update synchronization is needed or not based on the consumed amount out of the freely available amount by a user to be processed. The freely available amount is the maximum amount that can be used freely without any interference by another user in the group.

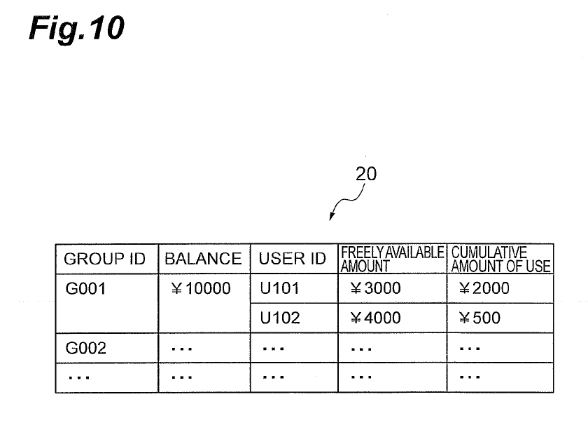

As shown in FIG. 10, the server balance information in this alternative example contains a group ID that identifies a group, a common balance in the group, a plurality of user IDs that identify users in the group, and a freely available amount and a cumulative amount of use of each user.

In the case where a user for whom processing is to be performed has already consumed a specified threshold or more (for example, 50% or more, ¥2000 or more etc.) of the freely available amount, the pre-update synchronization unit 33 determines that pre-update synchronization is needed and performs the synchronization as described in the above embodiment. On the other hand, when the amount of use of the freely available amount by the user is less than the threshold, the pre-update synchronization unit 33 determines to skip pre-update synchronization. This is because, when there is a sufficient freely available amount, even if the terminal balance changes independently in the payment terminal 10 of the user, the amount of change indicated by the instruction information is likely to be absorbed by the freely available amount.

For example, when the threshold is set to 50% in the example of FIG. 10, because the user “U101” has already consumed more than half of the freely available amount, the pre-update synchronization unit 33 determines that pre-update synchronization is needed for the user. On the other hand, because the user “U102” has consumed only less than half of the freely available amount, the pre-update synchronization unit 33 determines that pre-update synchronization is not needed for the user.

In this manner, by skipping pre-update synchronization when a certain amount of the freely available amount remains, it is possible to reduce the processing time for balance update.

Although the payment terminal 10 includes the IC chip 107 in the above embodiment, the present invention can be applied also to the case where the IC chip 107 is embedded in a smartcard 50. In this case, the electronic money application 11 in a payment terminal 10A can access the IC chip 107 and the electronic money storage unit 107a in the smartcard 50 using near field communication.

In the case where the pre-update synchronization unit and the post-update synchronization unit cannot perform synchronization processing at a certain change in the server balance, the pre-update synchronization unit and the post-update synchronization unit can perform processing including the suspended one in the next or later synchronization processing. For example, when synchronization processing cannot be carried out because the entire IC chip or the electronic money function is locked or a communication failure occurs, the pre-update synchronization unit and the post-update synchronization unit perform batch processing in the next or later synchronization processing. In this case, it is preferred that the pre-update synchronization unit, particularly, calculates the actual server balance using a difference between the terminal balance and the server balance before update by the same procedure as in Steps S19 to S22 in FIG. 8, in place of Steps S13 to S16 in FIG. 7, and then performs processing of withdrawal or deposit (Step S17) on the actual server balance. Note that, if the management server can control the locked/unlocked state of the IC chip, the management server may temporarily unlock the IC chip and perform synchronization processing, and then lock the IC chip again when the processing is done.

In the case where the upper limit is set to the balance of electronic money, the pre-update synchronization unit may perform pre-update synchronization even when the instruction information indicates deposit. Alternatively, the pre-update synchronization unit may skip pre-update synchronization just like in the above embodiment, and when the post-update synchronization unit determines that the balance of electronic money after update exceeds the upper limit, it may suspend processing of reflecting the amount of excess on the second balance until the next or later synchronization processing. In this case, the post-update synchronization unit reflects the amount of excess on the second balance in the next or later synchronization processing. In this manner, by processing the amount of excess of electronic money due to deposit later, it is possible to process all of the deposit amount eventually even when the upper limit is set to the balance of electronic money.

Alternatively, when the post-update synchronization unit determines that the balance of electronic money after update exceeds the upper limit, it may store the excess amount as a specified service different from electronic money (for example, an electronic coupon, an electronic ticket, points etc.) in association with a user ID into a specified database. In this manner, by converting the amount of excess of electronic money due to deposit into a different service, it is possible to process all of the deposit amount even when the upper limit is set to the balance of electronic money.

The pre-update synchronization unit may skip pre-update synchronization when the freely available amount of electronic money is set for the management server (to be more specific, the balance update unit), and the amount withdrawn by the balance update unit is within the freely available amount. In this case, the server balance information of each user contains the freely available amount on the server side and the cumulative amount of use on the server side (the cumulative total of the amounts withdrawn by the balance update unit).

The pre-update synchronization unit skips pre-update synchronization when the amount to be withdrawn is within the balance of the freely available amount indicated by the corresponding server balance information. On the other hand, when the cumulative amount of use exceeds the freely available amount by the processing of withdrawal, the pre-update synchronization unit performs pre-update synchronization. The processing of the balance update unit and the post-update synchronization unit after that is the same as described in the above embodiment. Accordingly, settlement processing is not cancelled only because the cumulative amount of use after withdrawal exceeds the freely available amount, and a change of the server balance and post-update synchronization are carried out in the same manner as in the above embodiment based on the assumption that pre-update synchronization is performed.

The freely available amount may be set by indicating a specific amount (for example, ¥6000 on the server side and ¥4000 on the terminal side) or a percentage (for example, 60% on the server side and 40% on the terminal side). Further, this method is applicable also to the above-described alternative example where one electronic money is shared among a plurality of users in a group. For example, in the example of FIG. 10, the freely available amount in the server is 10000−(3000+4000)=¥3000, and the management server can skip pre-update synchronization according to the amount of withdrawal within the range of the freely available amount. In this manner, by skipping pre-update synchronization processing when processing of the balance update unit is completed within the range of the freely available amount set for the balance update unit, it is possible to reduce the processing time for balance update.

### REFERENCE SIGNS LIST

1 . . . electronic money system, 10, 10A . . . payment terminal, 11 . . . electronic money application, 12 . . . state control unit, 13 . . . balance control unit, 20 . . . database, 30 . . . management server, 31 . . . chip monitoring unit, 32 . . . receiving unit, 33 . . . pre-update synchronization unit, 34 . . . balance update unit, 35 . . . post-update synchronization unit, 40 . . . payment processing terminal, 50 . . . smartcard, 107 . . . IC chip, 107a . . . electronic money storage unit, P1 . . . management program, P10 . . . main module, P11 . . . chip monitoring module, P12 . . . receiving module, P13 . . . pre-update synchronization module, P14 . . . balance update module, P15 . . . post-update synchronization module

1. An electronic money management device in an electronic money system that stores a balance of electronic money owned by a user in both of a storage device not under control of the user and a storage medium held by the user, comprising:
a post-update synchronization unit configured to, each time the balance in the storage device is updated based on instruction information for changing the balance in the storage device, reflect a change of the balance in the storage device on the balance in the storage medium through a terminal accessible to the storage medium held by the user having the updated balance; and
a pre-update synchronization unit configured to, before the balance in the storage device is updated based on the instruction information, acquire the balance in the storage medium from the terminal, and reflect a change of the balance in the storage medium on the balance in the storage device using the acquired balance in the storage medium, wherein
the pre-update synchronization unit skips processing of reflecting a change of the balance in the storage medium on the balance in the storage device when a specified condition is met.

2. (canceled)

3. The electronic money management device according to claim 1, wherein
the storage device stores balance information containing a user ID identifying a user, the balance in the storage device, information indicating a state of access restriction to the storage medium, and time when processing by the post-update synchronization unit is performed last time, and
when the pre-update synchronization unit determines that access to the storage medium has been restricted during a whole period from when processing by the post-update synchronization unit is performed last time to a current time by referring to the balance information corresponding to the user of the terminal, the pre-update synchronization unit skips processing of reflecting a change of the balance in the storage medium on the balance in the storage device.

4. The electronic money management device according to claim 1, wherein
the storage device stores balance information containing a user ID identifying a user, the balance in the storage device and information about the balance in the storage medium, and
when the pre-update synchronization unit determines that the balance in the storage medium is a specified threshold or more by referring to the balance information corresponding to the user of the terminal, the pre-update synchronization unit skips processing of reflecting a change of the balance in the storage medium on the balance in the storage device.

5. The electronic money management device according to claim 1, wherein
when the instruction information indicates deposit, the pre-update synchronization unit skips processing of reflecting a change of the balance in the storage medium on the balance in the storage device.

6. The electronic money management device according to claim 1, wherein
the storage device stores balance information containing a user ID identifying a user, the balance in the storage medium, and information indicating a consumed amount out of a freely available amount of the electronic money set for the balance in the storage device, and
when the pre-update synchronization unit determines that the consumed amount does not exceed the freely available amount by update of the balance in the storage device based on the instruction information by referring to the balance information corresponding to the user of the terminal, the pre-update synchronization unit skips processing of reflecting a change of the balance in the storage medium on the balance in the storage device.

7. The electronic money management device according to claim 4, wherein
when the pre-update synchronization unit skips processing of reflecting a change of the balance in the storage medium on the balance stored in the storage device, the post-update synchronization unit acquires the balance in the storage medium, recalculates the balance in the storage device after update based on a difference between the balance in the storage medium and the balance in the storage device before update, and transmits the recalculated balance in the storage device to the terminal to thereby reflect a change of the balance in the storage device on the balance in the storage medium.

8. (canceled)

9. The electronic money management device according to claim 5, wherein
when an upper limit is set to the balance of the electronic money, the pre-update synchronization unit skips processing of reflecting a change of the balance in the storage medium on the balance in the storage device, and the balance after reflecting a change of the balance in the storage medium on the balance in the storage device after update exceeds the upper limit, the post-update synchronization unit reflects an excess amount on the balance in the storage medium in next or later processing.

10. The electronic money management device according to claim 5, wherein
when an upper limit is set to the balance of the electronic money, the pre-update synchronization unit skips processing of reflecting a change of the balance in the storage medium on the balance in the storage device, and the balance after reflecting a change of the balance in the storage medium on the balance in the storage device after update exceeds the upper limit, the post-update synchronization unit associates an excess amount with the user as a specified service different from the electronic money.

11. An electronic money management device in an electronic money system that stores a balance of electronic money owned by a user in both of a storage device not under control of the user and a storage medium held by the user, comprising:
a post-update synchronization unit configured to, each time the balance in the storage device is updated based on instruction information for changing the balance in the storage device, reflect a change of the balance in the storage device on the balance in the storage medium through a terminal accessible to the storage medium held by the user having the updated balance; and
a pre-update synchronization unit configured to, before the balance in the storage device is updated based on the instruction information, acquire the balance in the storage medium from the terminal, and reflect a change of the balance in the storage medium on the balance in the storage device using the acquired balance in the storage medium, wherein
the storage device stores balance information containing a group ID identifying a group sharing one electronic money, a user ID identifying each of users included in the group, and information indicating a consumed amount out of a freely available amount of the electronic money set for each user, and
when the pre-update synchronization unit determines that the consumed amount is equal to or less than a specified threshold by referring to the balance information corresponding to the user of the terminal, the pre-update synchronization unit skips processing of reflecting a change of the balance in the storage medium on the balance in the storage device.

12-18. (canceled)

19. An electronic money management method performed by an electronic money management device in an electronic money system that stores a balance of electronic money owned by a user in both of a storage device not under control of the user and a storage medium held by the user, comprising:
a post-update synchronization step of, each time the balance in the storage device is updated based on instruction information for changing the balance in the storage device, reflecting a change of the balance in the storage device on the balance in the storage medium through a terminal accessible to the storage medium held by the user having the updated balance; and
a pre-update synchronization step of, before the balance in the storage device is updated based on the instruction information, acquiring the balance in the storage medium from the terminal, and reflecting a change of the balance in the storage medium on the balance in the storage device using the acquired balance in the storage medium, wherein
in the pre-update synchronization step, processing of reflecting a change of the balance in the storage medium on the balance in the storage device is skipped when a specified condition is met.
